(19) United States
(12) Patent Application Publication
(10) Pub. No.: US 2023/0234612 A1
(43) Pub. Date: Jul. 27, 2023

(54) SYSTEM FOR PREDICTING A LOCATION-BASED MANEUVER OF A REMOTE VEHICLE IN AN AUTONOMOUS VEHICLE

(71) Applicant: GM Global Technology Operations LLC, Detroit, MI (US)

(72) Inventors: Mohammad Naserian, Windsor (CA); Donald K. Grimm, Utica, MI (US)

(21) Appl. No.: 17/583,693

(22) Filed: Jan. 25, 2022

(51) Int. Cl. B60W 60/00; B60W 30/09; B60W 30/095; B60W 30/18; B60W 40/04

(52) U.S. Cl. CPC B60W 60/0011; B60W 60/00274; B60W 30/09; B60W 30/0956; B60W 30/18159; B60W 40/04; B60W 2554/4042; B60W 2554/4044; B60W 2554/4045; B60W 2554/801; B60W 2554/802; B60W 2556/10

(57) ABSTRACT

A system for an autonomous vehicle that predicts a location-based maneuver of a remote vehicle located in a surrounding environment includes one or more vehicle sensors collecting sensory data indicative of one or more vehicles located in the surrounding environment. The system also includes one or more automated driving controllers in electronic communication with the one or more vehicle sensors. The one or more automated driving controllers execute instructions to compare a lane of travel of the remote vehicle with a current lane of travel of the autonomous vehicle. In response to determining the lane of travel of the remote vehicle is a different lane than the current lane of the autonomous vehicle, the one or more automated driving controllers predict the location-based maneuver of the remote vehicle based on aggregated vehicle metrics that are based on historical data collected at the specific geographical location.

### INTRODUCTION

The present disclosure relates to a system for an autonomous vehicle, where the system predicts a location-based maneuver of a remote vehicle located in a surrounding environment. The system also determines an adaptive maneuver that the autonomous vehicle performs in response to predicting the location-based maneuver of the remote vehicle.

Autonomous vehicles may employ a variety of technologies that collect sensory information to detect their surroundings such as, but not limited to, radar, laser light, global positioning systems (GPS), and cameras. The autonomous vehicle may interpret the sensory information collected by the variety of sensors to identify appropriate navigation paths, as well as obstacles and relevant signage. Autonomous vehicles provide numerous advantages such as, for example, increased roadway capacity and reduced traffic congestion. Autonomous vehicles also relieve vehicle occupants from driving and navigation chores, allowing them to do other tasks during long and intense traffic journeys. However, there are still some challenges that autonomous vehicles experience. For example, autonomous vehicles are presently unable to predict the probability that a remote vehicle will perform a maneuver or undergo a change in vehicle speed in the immediate future, which in turn may affect motion planning.

Thus, while current autonomous vehicles achieve their intended purpose, there is a need in the art for an approach for a system that predicts the probability that a remote vehicle will perform a maneuver or undergo a change in vehicle speed in the immediate future.

### SUMMARY

According to several aspects, a system for an autonomous vehicle that predicts a location-based maneuver of a remote vehicle located in a surrounding environment is disclosed. The system includes one or more vehicle sensors collecting sensory data indicative of one or more vehicles located in the surrounding environment and one or more automated driving controllers in electronic communication with the one or more vehicle sensors. The one or more automated driving controllers executes instructions to monitor the one or more vehicle sensors for the sensory data. The one or more automated driving controllers identify the remote vehicle located in a specific geographical location relative to the autonomous vehicle based on the sensory data. The automated driving controllers determine a lateral distance and a longitudinal distance between the remote vehicle and the autonomous vehicle. The one or more automated driving controllers compare the lateral distance and the longitudinal distance with respective threshold distance values based on the sensory data. In response to determining the lateral distance and the longitudinal distance are less than the respective threshold distance values, the one or more automated driving controllers determine a lane of travel of the remote vehicle based on the sensory data. The one or more automated driving controllers compare the lane of travel of the remote vehicle with a current lane of travel of the autonomous vehicle. In response to determining the lane of travel of the remote vehicle is a different lane than the current lane of the autonomous vehicle, the one or more automated driving controllers predict the location-based maneuver of the remote vehicle based on aggregated vehicle metrics that are based on historical data collected at the specific geographical location. The one or more automated driving controllers determine an adaptive maneuver that the autonomous vehicle performs in response to predicting the location-based maneuver of the remote vehicle.

In an aspect, the remote vehicle is located in front of the autonomous vehicle, and where the remote vehicle travels in the same direction as the autonomous vehicle.

In another aspect, the location-based maneuver of the remote vehicle is a lane change.

In yet another aspect, the one or more automated driving controllers execute instructions to compare the lateral distance with a maximum threshold lateral distance value that is part of the aggregated vehicle metrics. The one or more controllers determine the lateral distance is less than the maximum threshold lateral distance value. In response to determining the lateral distance is less than the maximum threshold lateral distance value, the one or more automated driving controllers determine a probability that the remote vehicle performs the lane change from a lane of travel into a current lane that the autonomous vehicle is located based on the aggregated vehicle metrics.

In an aspect, the remote vehicle travels in an opposite direction from the autonomous vehicle. The autonomous vehicle and the remote vehicle are both located at a four-way intersection.

In another aspect, the location-based maneuver is a turn at the four-way intersection.

In yet another aspect, the one or more automated driving controllers execute instructions to compare the lateral distance with a maximum threshold lateral distance value that is part of the aggregated vehicle metrics. The one or more automated driving controllers determine the lateral distance is less than the maximum threshold lateral distance value. In response to determining the lateral distance is less than the maximum threshold lateral distance value, the one or more automated driving controllers determine a probability that the remote vehicle performs a turn from a four-way intersection based on the aggregated vehicle metrics.

In an aspect, the adaptive maneuver is either decelerating the autonomous vehicle or having the autonomous vehicle come to a stop.

In another aspect, the historical data is collected over a period of time and represents overall vehicle behavior in the specific geographical location.

In yet another aspect, the historical data accounts for changes in overall vehicle behavior based on a time of day, a day of the week, and zoning rules.

In an aspect, the historical data may include discrete profiles for a unique geographical location based on different times of the day or day of the week.

In another aspect, the adaptive maneuver includes a deceleration or stop, increasing a longitudinal distance between the autonomous vehicle and the remote vehicle, merging left or right, or changing lanes.

In an aspect, a method for predicting a location-based maneuver of a remote vehicle located in a surrounding environment. The method includes monitoring, by one or more controllers, one or more vehicle sensors for sensory data. The one or more vehicle sensors are part of an autonomous vehicle and collect sensory data indicative of one or more vehicles located in the surrounding environment. The method includes identifying, by the one or more controllers, the remote vehicle located in a specific geographical location relative to the autonomous vehicle based on the sensory data. The method includes determining a lateral distance and a longitudinal distance between the remote vehicle and the autonomous vehicle. The method includes comparing the lateral distance and the longitudinal distance with respective threshold distance values based on the sensory data. In response to determining the lateral distance and the longitudinal distance are less than the respective threshold distance values, the method includes determining a lane of travel of the remote vehicle based on the sensory data. The method includes comparing the lane of travel of the remote vehicle with a current lane of travel of the autonomous vehicle. In response to determining the lane of travel of the remote vehicle is a different lane than the current lane of the autonomous vehicle, the method includes predicting the location-based maneuver of the remote vehicle based on aggregated vehicle metrics that are based on historical data collected at the specific geographical location relative to the autonomous vehicle. Finally, the method includes determining an adaptive maneuver that the autonomous vehicle performs in response to predicting the location-based maneuver of the remote vehicle.

In an aspect, a system for an autonomous vehicle that predicts a change in vehicle speed of a remote vehicle located in a surrounding environment is disclosed. The system includes one or more vehicle sensors collecting sensory data indicative of one or more vehicles located in the surrounding environment; and one or more automated driving controllers in electronic communication with the one or more vehicle sensors. The one or more automated driving controllers executes instructions to monitor the one or more vehicle sensors for the sensory data, and identify the remote vehicle located in a specific geographical location relative to the autonomous vehicle based on the sensory data. The one or more controllers determine a lateral distance and a longitudinal distance between the remote vehicle and the autonomous vehicle. The one or more controllers compare the lateral distance and the longitudinal distance with respective threshold distance values based on the sensory data. In response to the determining the lateral distance and the longitudinal distance are less than the respective threshold distance values, the one or more controllers determine a lane of travel of the remote vehicle based on the sensory data. The one or more controllers compare the lane of travel of the remote vehicle with a current lane of travel of the autonomous vehicle. In response to determining the lane of travel of the remote vehicle is a different lane than the current lane of the autonomous vehicle, the one or more controllers predict the change in vehicle speed of the remote vehicle based on aggregated vehicle metrics that are based on historical data collected at the specific geographical location relative to the autonomous vehicle. Finally, the one or more controllers determine an adaptive maneuver that the autonomous vehicle performs in response to predicting the change in vehicle speed of the remote vehicle.

In an aspect, the change in vehicle speed is either a deceleration event or an acceleration event.

In another aspect, the remote vehicle travels in the same direction as the autonomous vehicle.

In yet another aspect, the historical data is collected over a period of time and represents overall vehicle behavior in the specific geographical location.

In an aspect, the historical data accounts for changes in overall vehicle behavior based on a time of day, a day of the week, and zoning rules.

In another aspect, the historical data may include discrete profiles for a unique geographical location based on different times of the day or day of the week.

In yet another aspect, the adaptive maneuver includes a deceleration or stop, increasing a longitudinal distance between the autonomous vehicle and the remote vehicle, merging left or right, or changing lanes.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of an exemplary vehicle including the disclosed system for predicting a location-based maneuver of a remote vehicle located in a surrounding environment, according to an exemplary embodiment;

FIG. 2A is a schematic diagram illustrating a situation where the autonomous vehicle is traveling in the same direction as the remote vehicle, according to an exemplary embodiment;

FIG. 2B is a schematic diagram illustrating a situation where the autonomous vehicle is traveling in an opposite direction as the remote vehicle at a four-way intersection, according to an exemplary embodiment;

FIG. 2C is a schematic diagram illustrating a situation where the autonomous vehicle is traveling in the same direction as the remote vehicle where the remote vehicle changes its vehicle speed, according to an exemplary embodiment;

FIG. 3 is a process flow diagram illustrating a method for predicting a location-based maneuver of the remote vehicle according to the situation shown in FIG. 2A, according to an exemplary embodiment;

FIG. 4 is a process flow diagram illustrating a method for predicting the location-based maneuver of the remote vehicle according to the situation shown in FIG. 2B, according to an exemplary embodiment; and

FIG. 5 is a process flow diagram illustrating a method for predicting a location-based maneuver of the remote vehicle according to the situation shown in FIG. 2C, according to an exemplary embodiment.

### DETAILED DESCRIPTION

The following description is merely exemplary in nature and is not intended to limit the present disclosure, application, or uses.

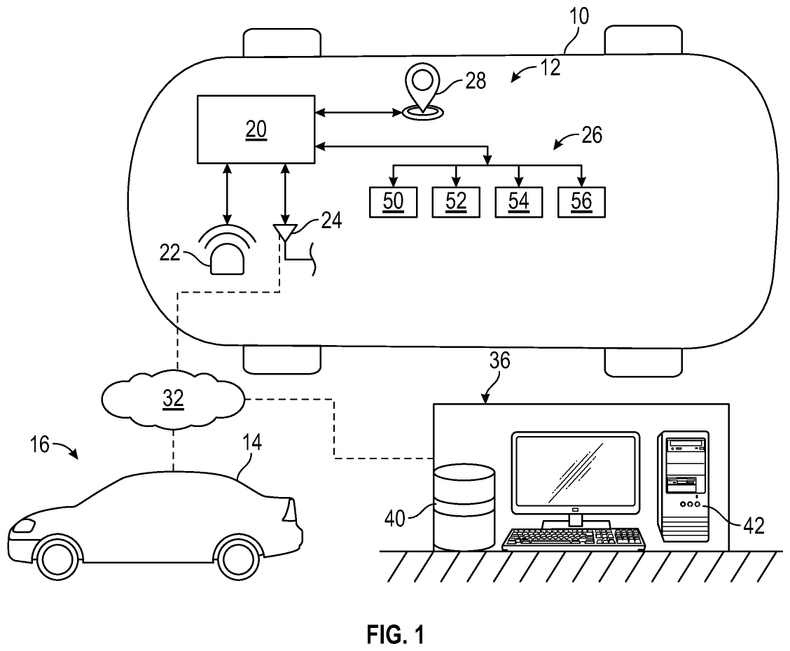

Referring to FIG. 1, an exemplary autonomous vehicle 10 including a system 12 for predicting a location-based maneuver of a remote vehicle 14 located in a surrounding environment 16 of the autonomous vehicle 10 is shown. The system 12 also determines an adaptive maneuver that the autonomous vehicle 10 performs in response to predicting the location-based maneuver of the remote vehicle 14. The system 12 includes one or more automated driving controllers 20 in electronic communication with one or more vehicle sensors 22, one or more antennas 24, a plurality of vehicle systems 26, and global positioning systems (GPS) 28. The one or more antennas 24 wirelessly connect the one or more automated driving controllers 20 of the autonomous vehicle 10 over a wireless network 32 with the remote vehicles 14 and a back-end office 36. For example, in one non-limiting embodiment, the one or more automated driving controllers 20 of the system 12 send and receive messages based on vehicle-to-infrastructure (V2X) to and from the remote vehicles 14 located within the environment 16. It is to be appreciated that the autonomous vehicle 10 may be any type of vehicle such as, but not limited to, a sedan, truck, sport utility vehicle, van, or motor home.

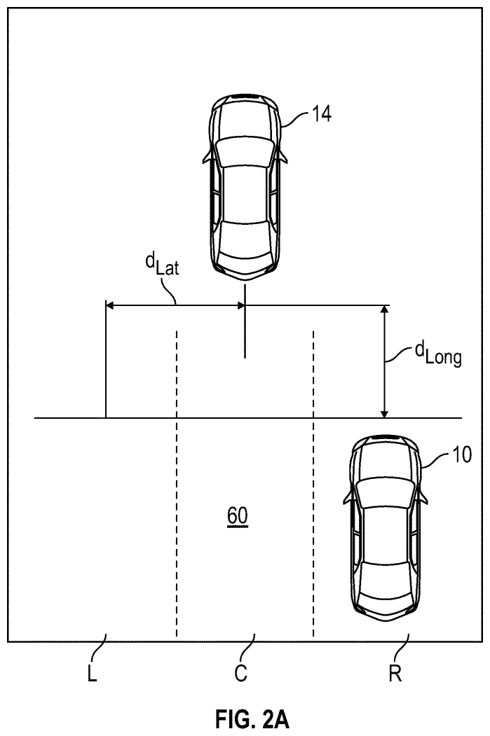

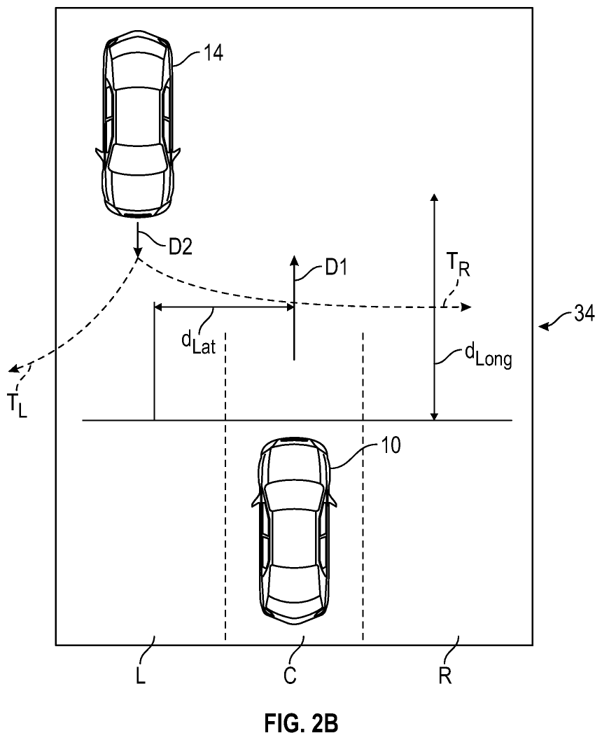

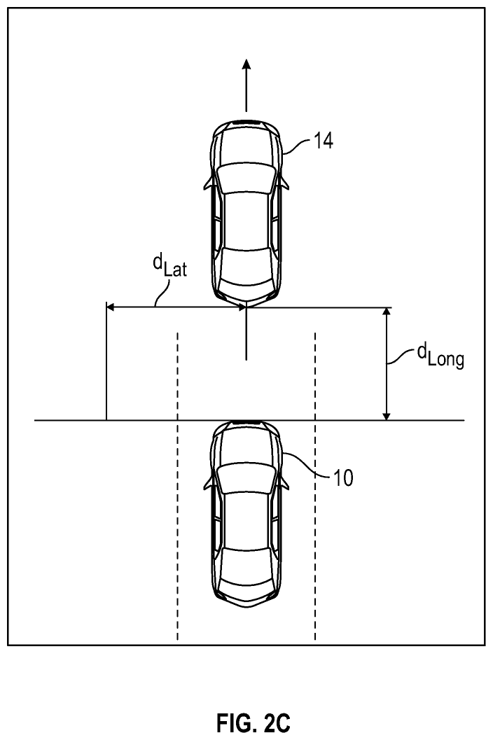

As explained below, the location-based maneuver of the remote vehicle 14 that is predicted by the system 12 is either a lane change performed by a remote vehicle 14 located in a position in front of the autonomous vehicle 10, where the autonomous vehicle 10 and the remote vehicle 14 travel in the same direction (seen in FIG. 2A). Alternatively, in the embodiment as shown in FIG. 2B, the location-based maneuver is a turn at a four-way intersection 34 while the remote vehicles 14 travel in an opposite direction with respect to the autonomous vehicle 10. In the embodiment as shown in FIG. 2C, the system 12 predicts that a remote vehicle 14 located in a position in front of the autonomous vehicle 10 while traveling in the same direction will undergo a change in vehicle speed, where the change in vehicle speed is either an acceleration event or a deceleration event. The system 12 also determines an adaptive maneuver that the autonomous vehicle 10 performs in response to predicting either the location-based maneuver of the remote vehicle 14 (FIGS. 2A and 2B) or a change in the remote vehicle speed (FIG. 2C). In embodiments, the adaptive maneuver includes a deceleration or stop, increasing a longitudinal distance between the autonomous vehicle 10 and the remote vehicle 14, merging left or right, or changing lanes. The adaptive maneuver is performed to compensate for the predicted location-based maneuver or change in vehicle speed of the remote vehicle 14. For example, the adaptive maneuver may be decelerating the autonomous vehicle 10 to increase headway between vehicles or to avoid close contact with a surrounding vehicle.

As explained below, the system 12 predicts the location-based maneuver of the remote vehicle 14 based on aggregated vehicle metrics that are based on historical data collected at a specific geographical location where the remote vehicle 14 is presently located. The aggregated vehicle metrics are stored in memory of the one or more automated driving controllers 20 or, in the alternative, by one or more databases 40 that are part of one or more centralized computers 42 located at the back-end office 36. The historical data that the aggregated vehicle metrics are based on is collected over a period of time and is representative of overall vehicle behavior in the specific geographical location. The overall vehicle behavior includes information such as vehicle speed, whether the vehicle accelerated or decelerated, and any possible maneuvers that were performed. In an embodiment, the aggregated vehicle metrics include the probability that the remote vehicle 14 will perform a specific maneuver at the specific geographical location. For example, the aggregated vehicle metrics may indicate eighty percent probability that a vehicle may continue straight at a specific intersection, a five percent probability the vehicle turns right, and a fifteen percent probability that the vehicle turns left.

The historical data accounts for changes in the overall vehicle behavior based on a time of day, a day of the week, and zoning rules. Some examples of zoning rules include, but are not limited to, areas of reduced speed during specific hours of the day such as school zones, and signage forbidding vehicles to perform specific maneuvers such as, for example, turning during a red light. In one embodiment, the historical data may include discrete profiles for a unique geographical location based on different times of the day or day of the week. For example, a first profile may be used during a morning rush hour time during the weekday, a second profile for an evening rush hour time during the weekday, and a third profile for weekends with respect to a unique geographical location. For example, if the specific geographical location is in a school zone, then the probability that a remote vehicle 14 may turn left or right at an intersection in a school zone may be significantly greater during the morning rush hour time during a weekday as parents drop off their children to school when compared to other times of the day, or on weekends.

Referring to FIG. 1, the one or more vehicle sensors 22 that collect sensory data related to one or more vehicles located in the surrounding environment 16. Some examples of the one or more vehicle sensors 22 include, but are not limited to, a radar and a camera. The plurality of vehicle systems 26 include, but are not limited to, a brake system 50, a steering system 52, a powertrain system 54, and a suspension system 56. The automated driving controller 20 sends vehicle control commands to the plurality of vehicle systems 26, thereby guiding the autonomous vehicle 10.

Referring to FIGS. 1 and 2A, the system 12 monitors the one or more vehicle sensors 22 for the sensory data and identifies the remote vehicle 14 located in the specific geographical location relative to the autonomous vehicle 10. In the example as shown in FIG. 2A, the remote vehicle 14 is located in a position in front of the autonomous vehicle 10 while traveling in the same direction, and a roadway 60 includes three lanes, a left lane L, a middle lane C, and a right lane R. In the embodiment as shown, the remote vehicle 14 is located in the center lane C and the autonomous vehicle 10 is located in the right lane R, however, it is to be appreciated that the figures are merely exemplary in nature, and the autonomous vehicle 10 and the remote vehicle 14 may be located in other lanes as well. The one or more automated driving controllers 20 also determine a lateral distance drat and a longitudinal distance d_{long} measured between the remote vehicle 14 and the autonomous vehicle 10 based on the sensory data collected by the one or more vehicle sensors 22.

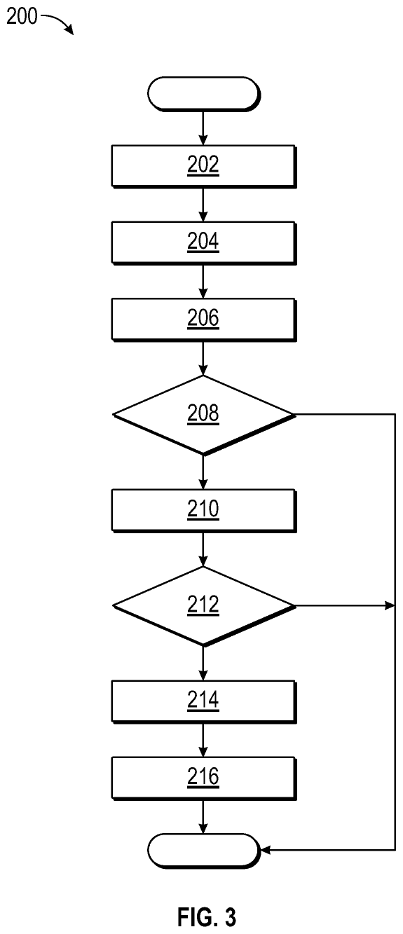

FIG. 3 is a process flow diagram illustrating a method 200 for predicting the location-based maneuver of the remote vehicle 14 shown in FIG. 2A, where the location-based maneuver is a lane change. Referring now to FIGS. 1, 2A, and 3, the method begins at block 202. In block 202, the one or more automated driving controllers 20 monitor the one or more vehicle sensors 22 for the sensory data. The method 200 may then proceed to block 204.

In block 204, the one or more automated driving controllers 20 identify the remote vehicle 14 located in the specific geographical location relative to the autonomous vehicle 10 based on the sensory data. In addition to the specific geographical location, the one or more automated driving controllers 20 also determine a direction of travel of the remote vehicle 14 relative to the autonomous vehicle 10. In the example as shown in FIG. 2A, the direction of travel of the remote vehicle 14 is in the same direction as the autonomous vehicle 10. The method 200 may then proceed to block 206.

In block 206, the one or more automated driving controllers 20 determine the lateral distance dₗₐₜ and the longitudinal distance d_{long} between the remote vehicle 14 and the autonomous vehicle 10 based on the sensory data. The method 200 may then proceed to block 208.

In block 208, the one or more automated driving controllers 20 compare the lateral distance dₗₐₜ and the longitudinal distance d_{long} with respective threshold distance values. That is, the lateral distance dₗₐₜ is compared with a lateral threshold distance value and the longitudinal distance d_{long} is compared with a longitudinal threshold distance value.

The lateral threshold distance value and the longitudinal threshold distance value are part of the aggregated vehicle metrics that are stored in memory of the one or more automated driving controllers 20 or, in the alternative, by the one or more databases 40. When the lateral distance dₗₐₜ is less than the lateral threshold distance value and the longitudinal distance d_{long} is less than longitudinal threshold distance value, the one or more automated driving controllers 20 determine a potential change in motion of the autonomous vehicle 10. The potential change in motion occurs when the remote vehicle 14 performs the location-based maneuver. For example, in the embodiment as shown in FIG. 2A, the potential change in motion is when the remote vehicle 14 changes lanes from the center lane C to the right lane R. In addition to the lateral distance dₗₐₜ and the longitudinal distance d_{long}, in an embodiment the potential change is also determined based on factors such as, for example, road shape and speed limit.

In response to determining the lateral distance dₗₐₜ is less than the lateral threshold distance value and the longitudinal distance d_{long} is less than longitudinal threshold distance value, the method 200 may proceed to block 210. Otherwise, the method 200 terminates.

In block 210, in response to determining the lateral distance dₗₐₜ and the longitudinal distance d_{long} are less than the respective threshold distance values, the one or more automated driving controllers 20 determine a lane of travel of the remote vehicle 14 based on the sensory data. In the example as shown in FIG. 2A, the lane of travel of the remote vehicle 14 is the center lane C. The method 200 may proceed to block 212.

In block 212, the one or more automated driving controllers 20 compare the lane of travel of the remote vehicle 14 with a current lane of the autonomous vehicle 10. In response to the one or more automated driving controllers 20 determining both the autonomous vehicle 10 and the remote vehicle 14 are traveling in the same lane, the method 200 may terminate. However, in response to determining the lane of travel of the remote vehicle 14 is different than the current lane of the autonomous vehicle 10, the method 200 may then proceed to block 214.

In block 214, in response to determining the lane of travel of the remote vehicle 14 is different than the current lane of the autonomous vehicle 10, the one or more controllers 20 may predict the location-based maneuver of the remote vehicle 14 based on the aggregated vehicle metrics that are based on historical data collected at the specific geographical location relative to the autonomous vehicle 10.

In the example as shown in FIG. 2A, the location-based maneuver of the remote vehicle 14 is a lane change. Specifically, the one or more automated driving controllers 20 compare the lateral distance dₗₐₜ with a maximum threshold lateral distance value that is part of the aggregated vehicle metrics. In response to determining the lateral distance dₗₐₜ is less than the maximum threshold lateral distance value, the one or more automated driving controllers 20 determine a probability that the remote vehicle 14 performs a lane change from the lane of travel into the current lane that the autonomous vehicle 10 is located based on the aggregated vehicle metrics. In the example as shown, the one or more automated driving controllers 20 determine the probability that the remote vehicle 14 performs a lane change into the right lane R where the autonomous vehicle 10 is located. The one or more automated driving controllers 20 predict the remote vehicle 14 will perform the lane change if the probability that the remote vehicle 14 performs the lane change is greater than a threshold probability value. The method 200 may then proceed to block 216.

In block 216, the one or more automated driving controllers 20 determine the adaptive maneuver that the autonomous vehicle 10 performs in response to predicting the location-based maneuver of the remote vehicle 14. That is, in the example as shown in FIG. 2A, the one or more automated driving controllers 20 determine the adaptive maneuver in response to predicting the lane change of the remote vehicle 14. As mentioned above, the adaptive maneuver includes a deceleration or stop, increasing a longitudinal distance between the autonomous vehicle 10 and the remote vehicle 14, merging left or right, or changing lanes. The method 200 may then terminate.

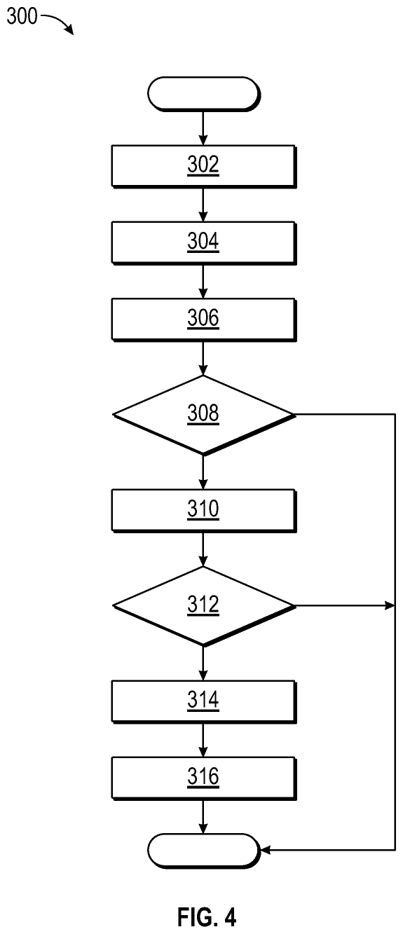

FIG. 4 is a process flow diagram illustrating a method 300 for predicting the location-based maneuver of the remote vehicle 14 shown in FIG. 2B, where the location-based maneuver is a turn at the four-way intersection 34. In the example as shown in FIG. 2B, the remote vehicle 14 travels in the opposite direction from the autonomous vehicle 10, where the autonomous vehicle 10 and the remote vehicle 14 are both located at the four-way intersection 34. In the example as shown in FIG. 2B, the autonomous vehicle 10 is located in center lane C traveling in a first direction D1, and remote vehicle 14 is located in the left lane L traveling in second direction D2 that is in the opposite direction of the first direction D1.

Referring now to FIGS. 1, 2B, and 4, the method begins at block 302. In block 302, the one or more automated driving controllers 20 monitor the one or more vehicle sensors 22 for the sensory data. The method 300 may then proceed to block 304.

In block 304, the one or more automated driving controllers 20 identify the remote vehicle 14 located in the specific geographical location relative to the autonomous vehicle 10 based on the sensory data. In the embodiment as shown in FIG. 2B, the specific geographical location is in a lane opposite the autonomous vehicle 10. In addition to the specific geographical location, the one or more automated driving controllers 20 also determine a direction of travel of the remote vehicle 14 relative to the autonomous vehicle 10. In the example as shown in FIG. 2B, the remote vehicle 14 travels in the second direction D2 opposite the first direction D1 of the autonomous vehicle 10. The method 300 may then proceed to block 306.

In block 306, the one or more automated driving controllers 20 determine the lateral distance dₗₐₜ and the longitudinal distance d_{long} between the remote vehicle 14 and the autonomous vehicle 10. The method 300 may then proceed to block 308.

In block 308, the one or more automated driving controllers 20 compare the lateral distance dₗₐₜ and the longitudinal distance d_{long} with respective threshold distance values. That is, the lateral distance dₗₐₜ is compared with the lateral threshold distance value and the longitudinal distance d_{long} is compared with the longitudinal threshold distance value. In response to determining the lateral distance dₗₐₜ is less than the lateral threshold distance value and the longitudinal distance d_{long} is less than longitudinal threshold distance value, the method 300 may proceed to block 310. Otherwise, the method 300 terminates.

In block 310, in response to determining the lateral distance chat and the longitudinal distance d_{long} are less than the respective threshold distance values, the one or more automated driving controllers 20 determine a lane of travel of the remote vehicle 14 based on the sensory data. In the example as shown in FIG. 2B, the lane of travel of the remote vehicle 14 is the left lane L. The method 300 may proceed to block 312.

In block 312, the one or more automated driving controllers 20 compare the lane of travel of the remote vehicle 14 with a current lane of the autonomous vehicle 10. In response to the one or more automated driving controllers 20 determining both the autonomous vehicle 10 and the remote vehicle 14 are traveling in the same lane, the method 300 may terminate. However, in response to determining the lane of travel of the remote vehicle 14 is different than the current lane of the autonomous vehicle 10, the method 300 may then proceed to block 314.

In block 314, in response to determining the lane of travel of the remote vehicle 14 is different than the current lane of the autonomous vehicle 10, the one or more automated driving controllers 20 predict the location-based maneuver of the remote vehicle 14 based on the aggregated vehicle metrics.

In the example as shown in FIG. 2B, the location-based maneuver of the remote vehicle 14 is a turn. Specifically, the one or more automated driving controllers 20 compare the lateral distance chat with a maximum threshold lateral distance value that is part of the aggregated vehicle metrics. In response to determining the lateral distance chat is less than the maximum threshold lateral distance value, the one or more automated driving controllers 20 determine a probability that the remote vehicle 14 performs a turn based on the aggregated vehicle metrics. In one embodiment, the one or more automated driving controllers 20 determine the probability that the remote vehicle 14 performs a left turn T_{L}. The one or more automated driving controllers 20 predict the remote vehicle 14 will perform the left turn T_{L} if the probability that the remote vehicle 14 performs the left turn T_{L} is greater than a threshold probability value. In the example as shown in FIG. 2B, if the autonomous vehicle 10 travels straight in the first direction, then the remote vehicle 14 performs a left turn across path (LTAP). If the autonomous vehicle 10 turns right, then the remote vehicle 14 performs a left turn into path (LTIP). Although a left turn T_{L} is described, the remote vehicle 14 may perform a right turn T_{R} instead. The method 300 may then proceed to block 316.

In block 316, the one or more automated driving controllers 20 determine the adaptive maneuver that the autonomous vehicle 10 performs in response to predicting the location-based maneuver of the remote vehicle 14. That is, in the example as shown in FIG. 2B, the one or more automated driving controllers 20 determine the adaptive maneuver in response to predicting either a left turn or a right turn at the four-way intersection 34, where the adaptive maneuver is either decelerating or having the autonomous vehicle 10 come to a stop. The method 300 may then terminate.

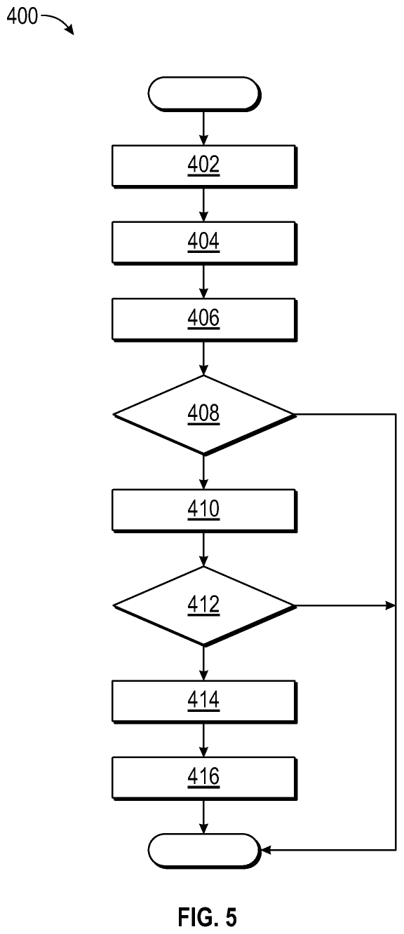

FIG. 5 is a process flow diagram illustrating a method 400 for predicting the change in vehicle speed of the remote vehicle 14 shown in FIG. 2C. In the example as shown in FIG. 2C, the remote vehicle 14 travels in the same direction as the autonomous vehicle 10, where the autonomous vehicle 10 and the remote vehicle 14 are both located in the same lane of travel. In the example as shown in FIG. 2C, both the autonomous vehicle 10 and the remote vehicle 14 are located in center lane C traveling in the same direction.

Referring now to FIGS. 1, 2C, and 5, the method begins at block 402. In block 402, the one or more automated driving controllers 20 monitor the one or more vehicle sensors 22 for the sensory data. The method 400 may then proceed to block 404.

In block 404, the one or more automated driving controllers 20 identify the remote vehicle 14 located in the specific geographical location relative to the remote vehicle 14 based on the sensory data. In addition to the specific geographical location, the one or more automated driving controllers 20 also determine a direction of travel of the remote vehicle 14 relative to the autonomous vehicle 10. In the example as shown in FIG. 2C, the remote vehicle 14 travels in the same direction as the autonomous vehicle 10. The method 400 may then proceed to block 406.

In block 406, the one or more automated driving controllers 20 determine the lateral distance dₗₐₜ and the longitudinal distance d_{long} between the remote vehicle 14 and the autonomous vehicle 10. The method 400 may then proceed to block 408.

In block 408, the one or more automated driving controllers 20 compare the lateral distance dₗₐₜ and the longitudinal distance d_{long} with respective threshold distance values. That is, the lateral distance dₗₐₜ is compared with the lateral threshold distance value and the longitudinal distance d_{long} is compared with the longitudinal threshold distance value. In response to determining the lateral distance dₗₐₜ is less than the lateral threshold distance value and the longitudinal distance d_{long} is less than longitudinal threshold distance value, the method 400 may proceed to block 410. Otherwise, the method 400 terminates.

In block 410, in response to determining the lateral distance dₗₐₜ and the longitudinal distance d_{long} are less than the respective threshold distance values, the one or more automated driving controllers 20 determine a lane of travel of the remote vehicle 14 based on the sensory data. In the example as shown in FIG. 2C, the lane of travel of the remote vehicle 14 is the center lane C. The method 400 may proceed to block 412.

In block 412, the one or more automated driving controllers 20 compare the lane of travel of the remote vehicle 14 with a current lane of the autonomous vehicle 10. In response to the one or more automated driving controllers 20 determining both the autonomous vehicle 10 and the remote vehicle 14 are traveling in different lanes, the method 300 may terminate. However, in response to determining the lane of travel of the remote vehicle 14 is the same as the current lane of the autonomous vehicle 10, the method 400 may then proceed to block 414.

In block 414, in response to determining the lane of travel of the remote vehicle 14 is the same as the current lane of the autonomous vehicle 10, the one or more automated driving controllers 20 predict the change in vehicle speed of the remote vehicle 14 based on the aggregated vehicle metrics that are based on historical data collected at the specific geographical location relative to the autonomous vehicle 10. In the example as shown in FIG. 2C, the change in vehicle speed is either an acceleration event or a deceleration event. Specifically, the one or more automated driving controllers 20 predict the change in vehicle speed of the remote vehicle 14 based on the historical data collected at the specific geographical location relative to the autonomous vehicle 10. The historical data indicates the overall vehicle behavior in the specific geographical location, and in the present example the historical data includes data indicating when vehicles located in the specific geographical region accelerate, decelerate, or continue to operate at about the same vehicle speed. The method 400 may then proceed to block 416.

In block 416, the one or more automated driving controllers 20 determine the adaptive maneuver that the autonomous vehicle 10 performs in response to predicting the change in vehicle speed of the remote vehicle 14. That is, in the example as shown in FIG. 2C, the one or more automated driving controllers 20 determine the adaptive maneuver in response to predicting either the acceleration event or the deceleration event, where the adaptive maneuver is either decelerating or having the autonomous vehicle 10 come to a stop. The method 400 may then terminate.

Referring generally to the figures, the disclosed system provides various technical effects and benefits by providing an approach to predict the behavior of vehicles surrounding the host or autonomous vehicle. The prediction is determined based on aggregated vehicle metrics that are based on historical data collected at the specific geographical location of the remote vehicle. The system also determines adaptive maneuvers for the autonomous vehicle to perform to accommodate the behavior of the remote vehicle. Thus, the disclosed system anticipates likely maneuvers by surrounding vehicles and instructs the autonomous vehicle to react to the likely maneuvers, thereby allowing the autonomous vehicle to operate more naturalistically in traffic.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for an autonomous vehicle that predicts a location-based maneuver of a remote vehicle located in a surrounding environment, the system comprising:
one or more vehicle sensors collecting sensory data indicative of one or more vehicles located in the surrounding environment; and
one or more automated driving controllers in electronic communication with the one or more vehicle sensors, wherein the one or more automated driving controllers executes instructions to:
monitor the one or more vehicle sensors for the sensory data;
identify the remote vehicle located in a specific geographical location relative to the autonomous vehicle based on the sensory data;
determine a lateral distance and a longitudinal distance between the remote vehicle and the autonomous vehicle;
compare the lateral distance and the longitudinal distance with respective threshold distance values based on the sensory data;
in response to determining the lateral distance and the longitudinal distance are less than the respective threshold distance values, determine a lane of travel of the remote vehicle based on the sensory data;
compare the lane of travel of the remote vehicle with a current lane of travel of the autonomous vehicle;
in response to determining the lane of travel of the remote vehicle is a different lane than the current lane of the autonomous vehicle, predict the location-based maneuver of the remote vehicle based on aggregated vehicle metrics that are based on historical data collected at the specific geographical location; and
determine an adaptive maneuver that the autonomous vehicle performs in response to predicting the location-based maneuver of the remote vehicle.

2. The system of claim 1, wherein the remote vehicle is located in front of the autonomous vehicle, and wherein the remote vehicle travels in the same direction as the autonomous vehicle.

3. The system of claim 2, wherein the location-based maneuver of the remote vehicle is a lane change.

4. The system of claim 2, wherein the one or more automated driving controllers execute instructions to:
compare the lateral distance with a maximum threshold lateral distance value that is part of the aggregated vehicle metrics;
determine the lateral distance is less than the maximum threshold lateral distance value; and
in response to determining the lateral distance is less than the maximum threshold lateral distance value, determine a probability that the remote vehicle performs the lane change from a lane of travel into a current lane that the autonomous vehicle is located based on the aggregated vehicle metrics.

5. The system of claim 1, wherein the remote vehicle travels in an opposite direction from the autonomous vehicle, and wherein the autonomous vehicle and the remote vehicle are both located at a four-way intersection.

6. The system of claim 5, wherein the location-based maneuver is a turn at the four-way intersection.

7. The system of claim 5, wherein the one or more automated driving controllers execute instructions to:
compare the lateral distance with a maximum threshold lateral distance value that is part of the aggregated vehicle metrics;
determine the lateral distance is less than the maximum threshold lateral distance value; and
in response to determining the lateral distance is less than the maximum threshold lateral distance value, determine a probability that the remote vehicle performs a turn from a four-way intersection based on the aggregated vehicle metrics.

8. The system of claim 1, wherein the adaptive maneuver is either decelerating the autonomous vehicle or having the autonomous vehicle come to a stop.

9. The system of claim 1, wherein the historical data is collected over a period of time and represents overall vehicle behavior in the specific geographical location.

10. The system of claim 1, wherein the historical data accounts for changes in overall vehicle behavior based on a time of day, a day of the week, and zoning rules.

11. The system of claim 1, wherein the historical data may include discrete profiles for a unique geographical location based on different times of the day or day of the week.

12. The system of claim 1, wherein the adaptive maneuver includes a deceleration or stop, increasing a longitudinal distance between the autonomous vehicle and the remote vehicle, merging left or right, or changing lanes.

13. A method for predicting a location-based maneuver of a remote vehicle located in a surrounding environment, the method comprising:
monitoring, by one or more controllers, one or more vehicle sensors for sensory data, wherein the one or more vehicle sensors are part of an autonomous vehicle and collect sensory data indicative of one or more vehicles located in the surrounding environment;
identifying, by the one or more controllers, the remote vehicle located in a specific geographical location relative to the autonomous vehicle based on the sensory data;
determining a lateral distance and a longitudinal distance between the remote vehicle and the autonomous vehicle;
comparing the lateral distance and the longitudinal distance with respective threshold distance values based on the sensory data;
in response to determining the lateral distance and the longitudinal distance are less than the respective threshold distance values, determining a lane of travel of the remote vehicle based on the sensory data;
comparing the lane of travel of the remote vehicle with a current lane of travel of the autonomous vehicle;
in response to determining the lane of travel of the remote vehicle is a different lane than the current lane of the autonomous vehicle, predicting the location-based maneuver of the remote vehicle based on aggregated vehicle metrics that are based on historical data collected at the specific geographical location relative to the autonomous vehicle; and
determining an adaptive maneuver that the autonomous vehicle performs in response to predicting the location-based maneuver of the remote vehicle.

14. A system for an autonomous vehicle that predicts a change in vehicle speed of a remote vehicle located in a surrounding environment, the system comprising:
one or more vehicle sensors collecting sensory data indicative of one or more vehicles located in the surrounding environment; and
one or more automated driving controllers in electronic communication with the one or more vehicle sensors, wherein the one or more automated driving controllers executes instructions to:
monitor the one or more vehicle sensors for the sensory data;
identify the remote vehicle located in a specific geographical location relative to the autonomous vehicle based on the sensory data;
determine a lateral distance and a longitudinal distance between the remote vehicle and the autonomous vehicle;
compare the lateral distance and the longitudinal distance with respective threshold distance values based on the sensory data;
in response to the determining the lateral distance and the longitudinal distance are less than the respective threshold distance values, determine a lane of travel of the remote vehicle based on the sensory data;
compare the lane of travel of the remote vehicle with a current lane of travel of the autonomous vehicle;
in response to determining the lane of travel of the remote vehicle is a different lane than the current lane of the autonomous vehicle, predict the change in vehicle speed of the remote vehicle based on aggregated vehicle metrics that are based on historical data collected at the specific geographical location relative to the autonomous vehicle; and
determine an adaptive maneuver that the autonomous vehicle performs in response to predicting the change in vehicle speed of the remote vehicle.

15. The system of claim 14, wherein the change in vehicle speed is either a deceleration event or an acceleration event.

16. The system of claim 14, wherein the remote vehicle travels in the same direction as the autonomous vehicle.

17. The system of claim 14, wherein the historical data is collected over a period of time and represents overall vehicle behavior in the specific geographical location.

18. The system of claim 14, wherein the historical data accounts for changes in overall vehicle behavior based on a time of day, a day of the week, and zoning rules.

19. The system of claim 14, wherein the historical data may include discrete profiles for a unique geographical location based on different times of the day or day of the week.

20. The system of claim 14, wherein the adaptive maneuver includes a deceleration or stop, increasing a longitudinal distance between the autonomous vehicle and the remote vehicle, merging left or right, or changing lanes.
